(19) United States
(12) Patent Application Publication
(10) Pub. No.: US 2016/0333835 A1
(43) Pub. Date: Nov. 17, 2016

(54) CAPILLARY FUEL INJECTOR AND METHOD AND SYSTEM FOR GENERATING POWER BY COMBUSTION OF VAPORIZED OR AEROSOLIZED FUEL MIXTURES

(71) Applicant: ALTRIA CLIENT SERVICES LLC, Richmond, VA (US)

(72) Inventors: Mimmo Elia, Belmont, MA (US); Jason Targoff, Cambridge, MA (US)

(21) Appl. No.: 15/087,575

(22) Filed: Mar. 31, 2016

Related U.S. Application Data
(60) Provisional application No. 62/162,348, filed on May 15, 2015.

(51) Int. Cl. F02M 53/06; F02M 53/02; F02M 43/04; F02M 59/46; F02M 61/16; F02D 41/30; F02M 53/04

(52) U.S. Cl. CPC F02M 53/06; F02D 41/3005; F02M 53/02; F02M 53/046; F02M 59/466; F02M 61/166; F02M 43/04; F02D 2200/021; F02D 2200/0414

(57) ABSTRACT

A fuel injector for delivering vaporized or aerosolized fuel mixtures to a spark ignited internal combustion engine. The fuel injector includes a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; at least one capillary flow passage positioned along the outer surface of the fuel injector body, the at least one capillary flow passage having an inlet end and an outlet end; and a heat source arranged along the at least one capillary flow passage, the heat source operable to heat the fuel within the at least one capillary flow passage to a level sufficient to permit at least a portion of the fuel to transition from a liquid state to a vapor state downstream of the fuel injector; wherein the valve assembly comprises a valve and a valve seat, the outlet end of the at least one capillary flow passage positioned adjacent to and upstream of the valve seat to minimize heat transfer from the heated fuel to the fuel injector. A fuel system having multi-fuel capability for delivering vaporized or aerosolized fuel mixtures to a spark ignited internal combustion engine and a method of operating a spark-ignited engine on middle-distillate fuel are also provided.

### RELATED APPLICATION

This patent application claims priority to U.S. Provisional Application Ser. No. 62/162,348, filed on May 15, 2015, (Attorney Docket 400276-20068), the contents of each are hereby incorporated by reference in their entirety.

### FIELD

The present disclosure relates to heated fuel injectors and systems and methods for their use in spark ignited internal combustion engines.

### ENVIRONMENT

The need to power portable electronics equipment, communications gear, medical devices and other equipment in remote field service has been on the rise in recent years, increasing the demand for efficient, mobile power systems. These applications require power sources that provide both high power and energy density, while also requiring minimal size and weight, and cost.

To date, batteries have been the principle means for supplying portable sources of power. However, due to the time required for recharging, batteries have proven inconvenient for continuous use applications. Moreover, portable batteries are generally limited to power production in the range of several milliwatts to a few watts and thus cannot address the need for significant levels of mobile, lightweight power production.

Small generators powered by internal combustion engines, whether gasoline- or diesel-fueled have also been used. However, field situations, particularly in military applications, can demand multi-fuel capabilities, and particularly require operation on diesel or jet fuel. Gas turbine powered generators possess multi-fuel capability and can produce power at high efficiencies. While relatively low-efficiency micro-turbines exist, the majority of gas turbine engines are large and not well suited to field applications requiring high mobility. The most practical power sources for field situations therefore have been relatively heavy diesel (compression ignition) engines, which have limitations in performance and non-optimal power densities at the small size ranges.

In view of these factors, a void exists with regard to power systems in the size range of 500 to 5000 watts. Moreover, in order to take advantage of high energy density liquid fuels, improved fuel preparation and delivery systems capable of low fueling rates are needed.

Therefore, what is needed is a portable power system having multi-fuel capabilities that takes advantage of high energy density liquid fuels, including middle-distillates such as diesel and jet fuels, with light weight spark ignition engines.

### SUMMARY

In one aspect, provided is a fuel injector for delivering vaporized or aerosolized fuel mixtures to a spark ignited internal combustion engine, comprising: a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; at least one capillary flow passage positioned along the outer surface of the fuel injector body, the at least one capillary flow passage having an inlet end and an outlet end; and a heat source arranged along the at least one capillary flow passage, the heat source operable to heat the fuel within the at least one capillary flow passage to a level sufficient to permit at least a portion of the fuel to transition from a liquid state to a vapor state downstream of the fuel injector; wherein the valve assembly comprises a valve and a valve seat, the outlet end of the at least one capillary flow passage positioned adjacent to and upstream of the valve seat to minimize heat transfer from the heated fuel to the fuel injector.

In some embodiments, the valve assembly and the solenoid cooperate to form an armature valve assembly, the armature valve assembly slidably resident within the fuel injector body, the armature valve assembly driven axially by the solenoid.

In some embodiments, the valve comprises a ball valve. In some embodiments, the valve comprises a pintle valve.

In some embodiments, the at least one capillary flow passage is formed within a tube. In some embodiments, the tube is formed from stainless steel, nickel-chromium alloy, or other resistive materials.

In some embodiments, the at least one capillary flow passage comprises a plurality of capillary flow passages. In some embodiments, the plurality of capillary flow passages form a bundle, the bundle helically wound about the outer surface of the fuel injector body. In some embodiments, the bundle is enclosed within an insulating cover.

In some embodiments, the fuel injector includes an orifice plate, the orifice plate positioned at the first end of the fuel injector body and downstream of the valve assembly.

In another aspect, provided is a fuel system having multi-fuel capability for delivering vaporized or aerosolized fuel mixtures to a spark ignited internal combustion engine, the fuel system comprising: at least one fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; and a controller programmed to control the heating of the at least one capillary flow passage to a level sufficient to permit at least a portion of the fuel to transition from a liquid state to a vapor state downstream of the at least one fuel injector, while preventing sustained phase transition from the liquid state to the vapor state within the at least one capillary flow passage.

In some embodiments, the fuel system includes a throttle body having a throttle, the throttle body structured and arranged to receive the at least one fuel injector, so as to enable the fuel to transition from the liquid state to the vapor state downstream of the at least one fuel injector into a region of reduced pressure.

In some embodiments, the valve assembly comprises a valve and a valve seat, the outlet end of the at least one capillary flow passage positioned adjacent to and upstream of the valve seat to minimize heat transfer from the heated fuel to the at least one fuel injector.

In some embodiments, the valve assembly and the solenoid cooperate to form an armature valve assembly, the armature valve assembly slidably resident within the fuel injector body, the armature valve assembly driven axially by the solenoid.

In some embodiments, the valve comprises a ball valve or a pintle valve.

In some embodiments, the at least one capillary flow passage is formed within a tube.

In some embodiments, the at least one capillary flow passage comprises a plurality of capillary flow passages. In some embodiments, the plurality of capillary flow passages form a bundle, the bundle helically wound about the outer surface of the fuel injector body. In some embodiments, the bundle is enclosed within an insulating cover.

In some embodiments, the fuel system includes an orifice plate, the orifice positioned at the first end of the fuel injector body and downstream of the valve assembly.

In some embodiments, prevention of sustained phase transition from the liquid state to the vapor state within the at least one capillary flow passage inhibits the formation of carbonaceous deposits on heated surfaces that come in contact with fuel.

In yet another aspect, provided is a portable engine or engine-generator combination having multi-fuel capability, comprising: a spark ignited internal combustion engine for powering an electrical generator, the spark ignited internal combustion engine having an air inlet and an exhaust; a fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; a throttle body positioned adjacent the air inlet of the spark ignited internal combustion engine, the throttle body having a throttle, the throttle body structured and arranged to receive the fuel injector; and a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

In some embodiments, the portable engine or engine-generator combination includes a throttle position sensor for detecting throttle position and sending a signal to the controller, the controller programmed to adjust fueling and/or engine parameters in response thereto.

In some embodiments, the portable engine or engine-generator combination includes an intake manifold air temperature sensor for detecting intake manifold air temperature and sending a signal to the controller, the controller programmed to adjust fueling and/or engine parameters in response thereto.

In some embodiments, the portable engine or engine-generator combination includes an engine block temperature sensor, for detecting engine block temperature and sending a signal to the controller, the controller programmed to adjust fueling and/or engine parameters in response thereto.

In some embodiments, the controller further comprises an engine controller, a fueling and battery management controller, and a fuel injector heating controller.

In some embodiments, the valve assembly comprises a valve and a valve seat, the outlet end of the at least one capillary flow passage positioned proximate to and upstream of the valve seat.

In some embodiments, the valve comprises a ball valve or a pintle valve.

In some embodiments, the at least one capillary flow passage is formed within a tube.

In some embodiments, the at least one capillary flow passage comprises a plurality of capillary flow passages. In some embodiments, the plurality of capillary flow passages form a bundle, the bundle helically wound about the outer surface of the fuel injector body.

In some embodiments, prevention of sustained phase transition from the liquid state to the vapor state within the at least one capillary flow passage inhibits the formation of carbonaceous deposits on heated surfaces that come in contact with fuel.

In some embodiments, the portable engine or engine-generator combination includes a knock sensor for detecting engine knock and sending a signal to the controller, the controller programmed to adjust fueling and/or engine parameters in response thereto.

In some embodiments, the portable engine or engine-generator combination includes an ignition signal detected by the controller, the controller programmed to adjust fueling and/or engine parameters in response thereto.

In still yet another aspect, provided is a kit of parts for converting a gasoline-powered engine or portable engine-generator combination to enable multi-fuel capability, including middle-distillate fuels not typically compatible with spark ignition engines, comprising: a fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; a throttle body having a throttle, the throttle body structured and arranged to receive the fuel injector, and a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

In some embodiments, the kit of parts includes a throttle position sensor for detecting throttle position and sending a signal to the controller, the controller programmed to adjust fueling and/or engine parameters in response thereto.

In some embodiments, the kit of parts includes an intake manifold air temperature sensor for detecting intake manifold air temperature and sending a signal to the controller, the controller programmed to adjust fueling and/or engine parameters in response thereto.

In some embodiments, the kit of parts includes an engine block temperature sensor, for detecting engine block temperature and sending a signal to the controller, the controller programmed to adjust fueling and/or engine parameters in response thereto.

In some embodiments, the controller further includes an engine controller, a fueling and battery management controller, and a fuel injector heating controller.

In some embodiments, the valve assembly includes a valve and a valve seat, the outlet end of the at least one capillary flow passage positioned proximate to and upstream of the valve seat to minimize heat transfer from the heated fuel to the fuel injector.

In some embodiments, the valve comprises a ball valve or a pintle valve.

In some embodiments, the at least one capillary flow passage is formed within a tube.

In some embodiments, the at least one capillary flow passage comprises a plurality of capillary flow passages. In some embodiments, the plurality of capillary flow passages form a bundle, the bundle helically wound about the outer surface of the fuel injector body.

In some embodiments, prevention of sustained phase transition from the liquid state to the vapor state within the at least one capillary flow passage inhibits the formation of carbonaceous deposits on heated surfaces that come in contact with fuel.

In a further aspect, provided is a process for converting a gasoline-powered engine or portable generator to enable multi-fuel capability including middle-distillate fuels not typically compatible with spark ignition engines, comprising: providing a gasoline-powered portable generator, the generator comprising a spark ignited internal combustion engine, and an electrical generator, the spark ignited internal combustion engine having an air inlet; providing a throttle body for installation adjacent the air inlet of the spark ignited internal combustion engine, the throttle body having a throttle and structured and arranged to receive a fuel injector; providing a fuel injector for installing within the throttle body, the fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; and providing a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

In some embodiments, the process includes the step of providing a throttle position sensor for detecting throttle position and sending a signal to the controller, the controller programmed to adjust fueling and/or engine parameters in response thereto.

In some embodiments, the process includes the step of providing an intake manifold air temperature sensor for detecting intake manifold air temperature and sending a signal to the controller, the controller programmed to adjust fueling and/or engine parameters in response thereto.

In some embodiments, the process includes the step of providing an engine block temperature sensor, for detecting engine block temperature and sending a signal to the controller, the controller programmed to adjust fueling and/or engine parameters in response thereto.

In some embodiments, the controller further comprises an engine controller, a fueling and battery management controller, and a fuel injector heating controller.

In some embodiments, the valve assembly comprises a valve and a valve seat, the outlet end of the at least one capillary flow passage positioned proximate to and upstream of the valve seat. In some embodiments, the valve comprises a ball valve or a pintle valve.

In some embodiments, the at least one capillary flow passage is formed within a tube.

In some embodiments, the at least one capillary flow passage comprises a plurality of capillary flow passages. In some embodiments, the plurality of capillary flow passages form a bundle, the bundle helically wound about the outer surface of the fuel injector body.

In some embodiments, prevention of sustained phase transition from the liquid state to the vapor state within the at least one capillary flow passage inhibits the formation of carbonaceous deposits on heated surfaces that come in contact with fuel.

In a still further aspect, provided is a method of operating a spark-ignited engine on middle-distillate fuel comprising: supplying a middle-distillate fuel, in liquid form, to at least one capillary flow passage of a fuel injector; heating the middle-distillate fuel within the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage; and delivering a vaporized or aerosolized fuel mixture to a combustion chamber of the spark-ignited engine.

In some embodiments, aerosolization of the middle-distillate fuel is achieved while minimizing electrical heating requirements.

In some embodiments, heating the middle-distillate fuel vaporizes the lighter fractions of the middle-distillate fuel downstream of the fuel injector and atomizes the heavier fractions of the middle-distillate fuel to form an aerosolized fuel mixture.

In some embodiments, the aerosolized fuel mixture has a particle size distribution, a fraction of which is 25 μm or less prior to combustion.

In some embodiments, the method includes the step of passing the heated fuel through an orifice plate to enhance aerosolization.

In some embodiments, prevention of sustained phase transition from the liquid state to the vapor state within the at least one capillary flow passage inhibits the formation of carbonaceous deposits on heated surfaces that come in contact with fuel.

In a yet still further aspect, provided is a method of vaporizing or aerosolizing a full-boiling range fuel, comprising the steps of: supplying a full-boiling range fuel, in liquid form, to at least one heated flow passage; heating the full-boiling range fuel within the at least one heated flow passage to a level sufficient to permit a portion of the full-boiling range fuel to transition from a liquid state to a vapor state downstream of the at least one heated flow passage, subjecting the remaining liquid portion of the full-boiling range fuel downstream of the at least one heated flow passage fuel to partial flash vaporization to fully vaporize or aerosolize the full-boiling range fuel.

In some embodiments, the at least one heated flow passage comprises at least one capillary flow passage.

### BRIEF DESCRIPTION OF THE DRAWINGS

FIG. 1 presents a perspective view of an illustrative, non-exclusive example of a fuel injector, according to the present disclosure.

FIG. 2 presents a cross-sectional view of an illustrative, non-exclusive example of a fuel injector, according to the present disclosure.

FIG. 3 presents a schematic diagram of a system for controlling a spark-ignited engine having multi-fuel capability, according to the present disclosure.

FIG. 4 presents a bottom plan view of an illustrative, non-exclusive example of a throttle body having a fuel injector of the type depicted in FIGS. 1 and 2, according to the present disclosure.

FIG. 5 presents a perspective view of an illustrative, non-exclusive example of a portable engine-generator combination having multi-fuel capability, according to the present disclosure.

### DETAILED DESCRIPTION

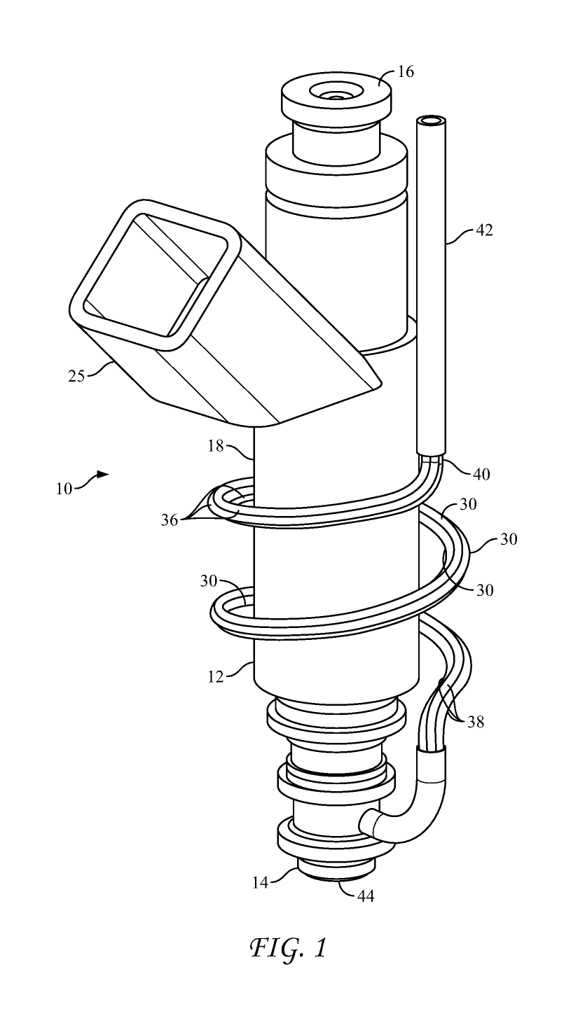

FIGS. 1-5 provide illustrative, non-exclusive examples of fuel injectors, fuel system components, and control systems having utility in connection with spark ignited engines and engine-generator combinations having multi-fuel capabilities, methods and systems, according to the present disclosure and/or of systems, apparatus, and/or assemblies that may include, be associated with, be operatively attached to, and/or utilize the fuel injectors disclosed herein. In FIGS. 1-5, like numerals denote like, or similar, structures and/or features; and each of the illustrated structures and/or features may not be discussed in detail herein with reference to each of FIGS. 1-5. Similarly, each structure and/or feature may not be explicitly labeled in each of FIGS. 1-5; and any structure and/or feature that is discussed herein with reference to any one of FIGS. 1-5 may be utilized with any other of FIGS. 1-5 without departing from the scope of the present disclosure.

In general, structures and/or features that are, or are likely to be, included in a given embodiment are indicated in solid lines in FIGS. 1-5, while optional structures and/or features are indicated in broken lines. However, a given embodiment is not required to include all structures and/or features that are illustrated in solid lines therein, and any suitable number of such structures and/or features may be omitted from a given embodiment without departing from the scope of the present disclosure.

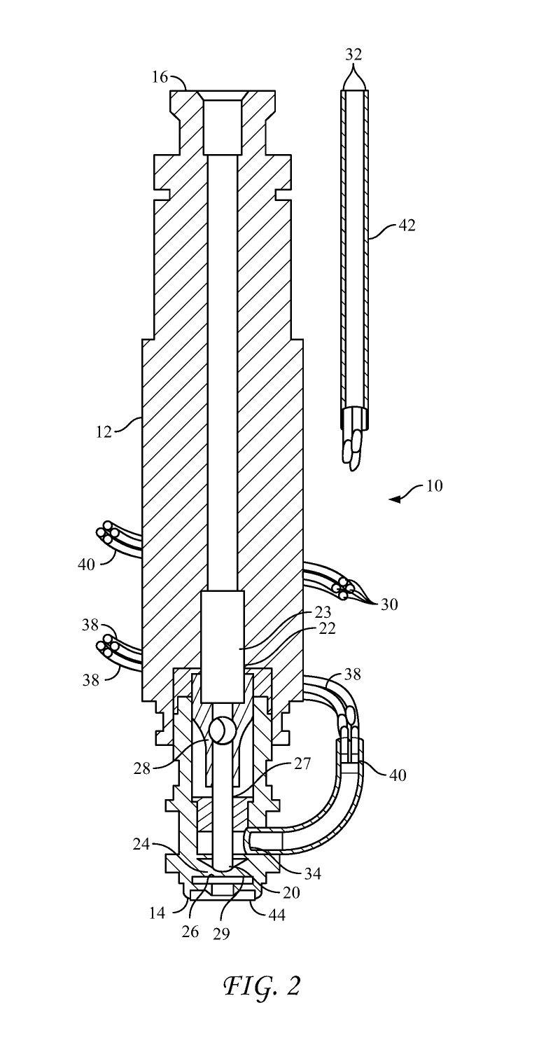

FIG. 1 presents a perspective view of an illustrative, non-exclusive example of a fuel injector 10 for delivering vaporized or aerosolized fuel mixtures to a spark ignited internal combustion engine, according to the present disclosure. The fuel injector 10 includes a fuel injector body 12 having a first end 14, a second end 16 and an outer surface 18. Referring also to the cross-sectional view of FIG. 2, the fuel injector body 12 includes a valve assembly 20 positioned within the fuel injector body 12 and adjacent the first end 14, and a solenoid 22 for actuating the valve assembly 20, the solenoid 22 also positioned within the fuel injector body 12 between the first end 14 and the second end 16.

Referring still to FIGS. 1 and 2, at least one capillary flow passage 30 is positioned along the outer surface 18 of the fuel injector body 12, the at least one capillary flow passage 30 having an inlet end 32 and an outlet end 34. A heat source 36 is arranged along the at least one capillary flow passage 30, the heat source 36 operable to heat the fuel within the at least one capillary flow passage 30 to a level sufficient to permit at least a portion of the fuel to transition from a liquid state to a vapor state downstream of the fuel injector 10.

As shown in FIG. 2, the valve assembly 20 comprises a valve 24 and a valve seat 26. To minimize heat loss to other fuel injector components, the outlet end 34 of the at least one capillary flow passage 30 is positioned adjacent to and upstream of the valve seat 26. The valve assembly 20 and the solenoid 22 cooperate to form an armature valve assembly 28. As shown, the armature valve assembly 28 may be structured and arranged so as to be slidably resident within the fuel injector body 12. In some embodiments, the armature valve assembly 28 is driven axially by the solenoid 22.

A wide variety of valve and valve seat configurations are contemplated for use herein. In some embodiments, the valve comprises a pintle valve 24. In some embodiments, the valve comprises a ball valve (not shown).

As is conventional, solenoid 22 has coil windings 23 that may be connected to an electrical connector 25 in any conventional manner. When the coil windings 23 are energized, a magnetic field is directed through solenoid element 27, which is connected to pintle valve 24, thereby causing it to lift from valve seat 26, exposing an orifice 29, and allowing fuel to flow. When electricity is cut off from the coil windings 23, pintle valve 24 returns to its original position.

As shown in FIGS. 1 and 2, in some embodiments, the at least one capillary flow passage 30 comprises a plurality of capillary flow passages. In some embodiments, the plurality of capillary flow passages 30 form a bundle 40, the bundle 40 helically wound about the outer surface 18 of the fuel injector body 12. In some embodiments, the bundle 40 is enclosed within an insulating cover 42.

It has been found that the use of a heated capillary bundle 40 external to the capillary body 12 tends to reduce the thermal-resistance requirements of the internal components of fuel injectors 10. Components benefiting from this configuration include the solenoid 22 and the armature valve assembly 28 and other internal components of fuel injector 10.

To aid in the atomization of fuel, fuel injector 10 may also include an orifice plate 44. In some embodiments, the orifice plate 44 may be positioned at the first end 14 of the fuel injector body 14, downstream of the valve assembly 20. The sizing and number of orifices employed will depend upon the flow rate to be achieved. In the application highlighted herein, a single orifice on the order of about 0.010 inches has been found to be acceptable. As may be appreciated, the orifice plate serves to supply the back pressure necessary to achieve the desired flow rate.

As indicated above, a fuel injector in accordance herewith includes at least one capillary flow passage 30 through which pressurized fuel flows before being injected into an engine for combustion. A capillary flow passage can be provided with a hydraulic diameter that is preferably less than 2 mm, more preferably less than 1 mm, and most preferably less than 0.5 mm. Hydraulic diameter is used in calculating fluid flow through a fluid carrying element. Hydraulic radius is defined as the flow area of the fluid-carrying element divided by the perimeter of the solid boundary in contact with the fluid (generally referred to as the “wetted” perimeter). In the case of a fluid carrying element of circular cross section, the hydraulic radius when the element is flowing full is (πD²/4)/πD=D/4. For the flow of fluids in noncircular fluid carrying elements, the hydraulic diameter is used. From the definition of hydraulic radius, the diameter of a fluid-carrying element having circular cross section is four times its hydraulic radius. Therefore, hydraulic diameter is defined as four times the hydraulic radius.

As will be described in more detail below, heat is applied along the capillary passageway to heat the liquid fuel to a point that avoids sustained phase change from the liquid state. The heated fuel exits the capillary passageway substantially as a liquid, which flash vaporizes as it undergoes a sudden pressure drop upon exiting the fuel injector into the intake port or manifold. By avoiding sustained phase change from the liquid state, is meant that at least about 80%, or at least about 90%, or at least about 95% of the time the heated liquid fuel remains in the liquid state just prior to exiting the injector.

The capillary flow passage 30 may be formed in a capillary body such as a single or multilayer metal, ceramic or glass body. In some embodiments, the capillary flow passage 30 may be formed within a tube 38. In some embodiments, the tube 38 may be formed from stainless steel, nickel-chromium alloy, or other electrically resistive materials.

The heat source 36 (or heater) can be formed by a portion of the body such as a section of a stainless steel tube or nickel-chromium alloy tube, such as that sold under the trademark Inconel® (a registered trademark of the International Nickel Corporation) or the heater can be a discrete layer or wire of resistance heating material incorporated in or on the capillary body. The capillary flow passage 30 may be any shape comprising an enclosed volume opening to an inlet and an outlet and through which a fluid may pass. The capillary flow passage 30 may have any desired cross-section with one form having a circular cross-section of uniform diameter. Other capillary flow passage cross-sections include non-circular shapes such as triangular, square, rectangular, oval or other shape and the cross section of the fluid passage need not be uniform. The capillary flow passage 30 can extend rectilinearly or non-rectilinearly and may be a single fluid passage or multi-path fluid passage.

In the case where the capillary flow passage 30 is defined by a metal capillary tube, the tube can have an inner diameter of 0.01 to 3 mm, preferably 0.1 to 1 mm, most preferably 0.15 to 0.5 mm. Alternatively, the capillary flow passage 30 can be defined by transverse cross sectional area of the passage which can be 8×10⁻⁵ to 7 mm², preferably 8×10⁻³ to 8×10⁻¹ mm² and more preferably 2×10⁻² to 2×10⁻¹ mm² Many combinations of a single or multiple capillaries, various pressures, various capillary lengths, amounts of heat applied to the capillary, and different cross-sectional areas will suit a given application.

The liquid fuel is supplied to the capillary flow passage 30 under a pressure that is about the minimum pressure required to maintain the fuel in a liquid state, while at capillary temperature. As described herein, the capillary temperature is typically set to a level that is sufficient to yield at least partial or full vaporization upon exiting the fuel injector 10 into a lower pressure regime (flash vaporization). As such, fuel pressures of at least 40 psig, or at least 50 psig, or at least 60 psig or at least 70 psig or more are utilized. In the case where the capillary flow passage 30 is defined by the interior of a stainless steel tube having an internal diameter of approximately 0.020 inch and a length of approximately 6 inches, the fuel is preferably supplied to the capillary passageway at a pressure of 50 to 70 psig to achieve adequate mass flow rates (on the order of 100-1500 mg/s).

The at least one capillary flow passage 30 provides a sufficient flow of substantially vaporized fuel to ensure a stoichiometric or nearly stoichiometric mixture of fuel and air that can be ignited and combusted within the cylinder(s) of an engine. The capillary tube 38 that defines capillary flow passage 30 also is characterized by having a low thermal inertia, so that the capillary flow passage 30 can be brought up to the desired temperature for vaporizing fuel very quickly, within 2.0 seconds, or 0.5 second, or within 0.1 second, which is beneficial in applications involving cold starting an engine. The low thermal inertia also may provide advantages during normal operation of the engine, such as by improving the responsiveness of the fuel delivery to sudden changes in engine power demands.

One version of bundle 40 that may be employed includes four tubes of 18/8 stainless steel (AISI Type 304) having a 0.020 in. (0.051 cm) ID, a 0.032 in. (0.08 cm) OD, and a heated length of 6.00 in. (15.1 cm). Optimum power level for the bundle of four is in the range of 90-120 watts per 100-150 mg/sec of average fuel flow.

The fuel injectors disclosed herein can produce aerosolized fuel that forms a distribution of droplets that mostly range in size from 2 to 30 μm SMD with an average droplet size of about 5 to 15 μm SMD, when the fuel is condensed in air at ambient temperature. Fuel droplets having a size of less than about 25 μm have been shown to achieve rapid and nearly complete vaporization at cold-starting temperatures.

Alternatives for heating the tube along its length could include inductive heating, such as by an electrical coil positioned around the flow passage, or other sources of heat positioned relative to the flow passage to heat the length of the flow passage through one or a combination of conductive, convective or radiative heat transfer.

It has been found that sustained phase change from the liquid state to the vapor state within a heated capillary passage can result in the formation of deposits of carbon and/or heavy hydrocarbons, which accumulate on the capillary walls and the flow of fuel can be severely restricted and ultimately can lead to clogging of the capillary flow passage 30. The rate at which these deposits accumulate is a function of capillary wall temperature, fuel flow rate and fuel type. While the use of fuel additives may reduce such deposits, operating the heated capillary so as to avoid sustained phase change from the liquid state to the vapor state within the capillary flow passage has proven effective.

Although it may be difficult to prevent phase change from the liquid state 100% of the time, due to the complex physical effects that take place, nonetheless that would be desirable. These complex physical effects include variations in the boiling point of the fuel since the boiling point is pressure dependent and pressure can vary in the capillary flow passage. Thus, while it is believed that the fuel remains in the liquid state just prior to exiting the injector nearly all of the time, some vaporized fluid may also pass through the outlet of the capillary flow passage along with liquid fluid.

To implement a flash vaporization strategy that avoids sustained phase change from the liquid state to the vapor state within the capillary flow passage, knowledge of the distillation (or vapor) curve for the fuel of interest is required. For example, a vapor curve for commercial gasoline at atmospheric conditions (1 bar) normally ranges from an initial boiling point around (IBP) 20° C. to a final boiling point (FBP) around 200° C. The temperature at which 50% of the fuel is vaporized (T₅₀) typically falls in the 80° C. to 120° C. range. This vapor curve shifts to lower temperatures at sub-atmospheric conditions, such as in the intake port of an operating engine, and to higher temperatures at elevated pressures, such as the fuel pressure in the fuel system and fuel injector.

For a typical commercial gasoline, the temperature at which 50% is vaporized is close to 160° C. in the fuel injector, but may be as low as 80° C. in the intake port during idling. If the fuel in the fuel injector is maintained at 100° C., only a minute fraction will be vaporized. As this fuel leaves the injector nozzle and enters the intake manifold at idling conditions (0.4 bar), most of the liquid fuel will flash vaporize since the ambient pressure is now lower than the 75% vapor pressure.

When operating the fuel injectors disclosed herein on gasoline, after cold-start and warm-up, it is not necessary to heat the capillary bundle and the unheated capillaries can be used to supply adequate volumes of liquid fuel to an engine operating at normal temperature. After approximately 20 seconds (or preferably less) from starting the engine, the power used to heat the capillaries can be turned off and liquid injection initiated, for normal engine operation. Normal engine operation can be performed by liquid fuel injection via continuous injection or pulsed injection, as those skilled in the art will readily recognize.

While the aforementioned flash vaporization strategy, and the systems and methods disclosed herein, possess utility when employed with conventional gasoline, a wide-variety of other fuels may be employed advantageously, even when using virtually the same equipment, thus giving rise to the multi-fuel capabilities disclosed herein.

In some embodiments, middle distillate fuels, such as diesel fuel, jet fuel, oxygenated blends of middle distillate fuels, biofuels and biofuel blends and mixtures thereof may be employed. For example, a vapor curve for commercial diesel fuel at atmospheric conditions (1 bar) typically ranges from an initial boiling point around (IBP) 125° C. to a final boiling point (FBP) around 390° C. The temperature at which 50% of the fuel is vaporized (T₅₀) typically falls in the 230° C. to 280° C. range. Again, this vapor curve shifts to lower temperatures at sub-atmospheric conditions, such as in the intake port of an operating engine, and to higher temperatures at elevated pressures, such as the fuel pressure in the fuel system and fuel injector. When diesel fuel or jet fuel is delivered in a substantially-vaporized state, suitable performance may be achieved in a spark-ignition (SI) engine. Providing a spark-ignited engine with this capability is highly desirable, due to more favorable power densities than diesel (compression ignition) engines, particularly when a constant source of supply is not possible.

It has been discovered that good vaporization or aerosolization can be achieved without the need for a level of electrical energy that alone would be necessary to achieve that result. In other words, the electrical energy level required to heat a fuel to achieve good vaporization or aerosolization has been found to be significantly less than expected. While not wishing to be bound by theory, it is believed that the combination of fuel heating, pressure drop upon exiting the injector, and the use of the energy created by the expansion or vaporization of the lower boiling range components of a full-boiling range fuel to atomize the higher boiling range components of a full-boiling range fuel, serve to fully vaporize or aerosolize the fuel prior to combustion, thus reducing the energy requirements of the system. This mechanism is defined herein as “partial flash vaporization.” By “fuel boiling range fuel” is meant a fuel that boils over a broad range of temperatures, as is typical when distilling a gasoline or middle distillate fuel, such as diesel fuel, heating oil, jet fuel, kerosene, or blends, including oxygenated blends, thereof

In view thereof, disclosed herein is a method of vaporizing or aerosolizing a full-boiling range fuel. The method includes the steps of supplying a full-boiling range fuel, in liquid form, to at least one heated flow passage; heating the full-boiling range fuel within the at least one heated flow passage to a level sufficient to permit a portion of the full-boiling range fuel to transition from a liquid state to a vapor state downstream of the at least one heated flow passage, subjecting the remaining liquid portion of the full-boiling range fuel present downstream of the at least one heated flow passage fuel to partial flash vaporization to fully vaporize or aerosolize the full-boiling range fuel.

In some embodiments, the at least one heated flow passage comprises at least one capillary flow passage.

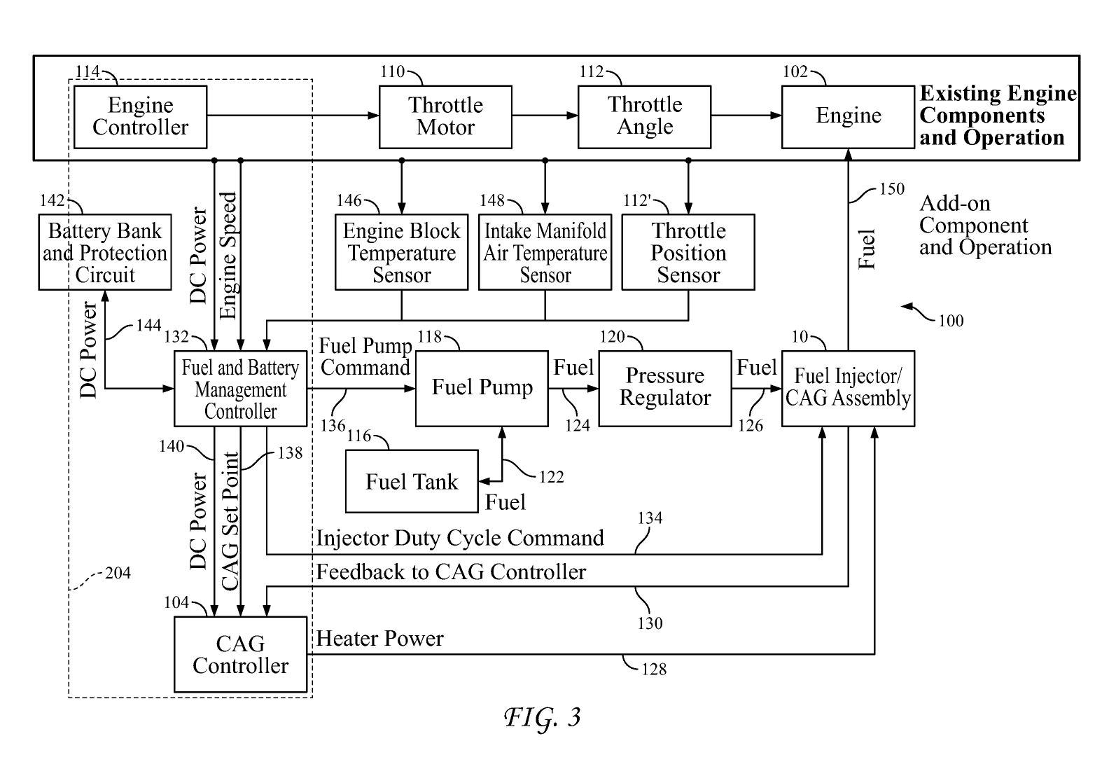

Referring now to FIG. 3, a fuel system 100 for delivering vaporized or aerosolized fuel mixture to a spark ignited internal combustion engine 102 is disclosed. Referring also to FIGS. 1 and 2, the fuel system 100 includes at least one fuel injector 10 which includes a fuel injector body 12 having a first end 14, a second end 16 and an outer surface 18. The fuel injector body 12 also includes a valve assembly 20 positioned within the fuel injector body 12 and adjacent the first end 14, and a solenoid 22 for actuating the valve assembly 20. The solenoid 22 may be positioned within the fuel injector body 12 between the first end 14 and the second end 16. At least one capillary flow passage 30 may be positioned along the outer surface 18 of the fuel injector body 12, the at least one capillary flow passage 30 having an inlet end 32 and an outlet end 34. A heat source 36 may be arranged along the at least one capillary flow passage 30.

Referring again to FIG. 3, a controller 104 is programmed to control the heating of the at least one capillary flow passage 30 to a level sufficient to permit at least a portion of the fuel to transition from a liquid state to a vapor state downstream of the at least one fuel injector 10, while preventing sustained phase transition from the liquid state to the vapor state within the at least one capillary flow passage 30.

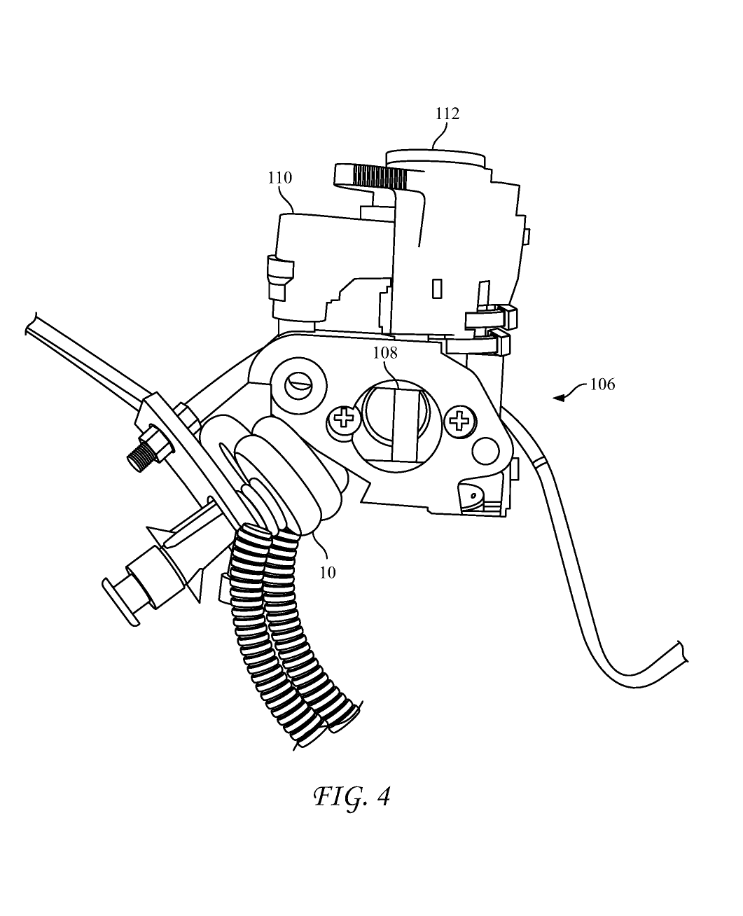

Referring also to FIG. 4, the fuel system 100 includes throttle body 106 having a throttle 108, the throttle body 106 structured and arranged to receive the at least one fuel injector 10. As disclosed herein, the use of the flash vaporization strategy and the fuel injector, systems and methods disclosed herein, enable the fuel to transition from the liquid state to the vapor state downstream of the at least one fuel injector 10 into a region of reduced pressure, that region located below the throttle 108. Throttle body 106 may also include a throttle motor 110 and a throttle angle sensor 112, as those skilled in the art would plainly recognize.

Referring again to FIG. 3, in a conventional spark ignition engine, such as those employed in a commercial portable generator, an engine controller 114 may be provided to control the throttle motor, throttle angle, and engine output.

Still referring to FIG. 3, the operation of the fuel injectors, systems and methods will now be described. Fuel is stored in fuel tank 116, and is provided through fuel line 122 to the fuel system by fuel pump 118, outputted through fuel line 124 to pressure regulator 120, which supplies fuel at the desired pressure through fuel line 126. The regulated source of fuel is then provided to the at least one fuel injector 10. The heating of the capillaries is controlled by controller 104, with current to the heater provided through electrical lead 128. An optional feedback loop 130 may be provided. A fuel and power management controller 132 may be provided, which may be used to provide a solenoid duty cycle command via lead 134 to the at least one fuel injector 10. Fuel and power management controller 132 also provides fuel pump commands via lead 136 to the fuel pump 118, as well as injector heating set point to the heater controller via lead 138. Power to the heating controller 104 may also be provided by fuel and power management controller 132 via lead 140. Fuel and power management controller 132 may also supply power to a battery bank and protection circuit via lead 144.

To further optimize engine operating parameters, one or more additional sensors may be employed. For example, in some embodiments an engine block temperature sensor 146 may be provided. Signals obtained from engine block temperature sensor 146 may be used by fuel and power management controller 132 to minimize the dilution of crankcase oil by fuel during cold engine operation. In a similar manner, an intake manifold air temperature sensor 148 may be employed to optimize fuel injector and other operating parameters. A throttle position sensor 112′ may be employed to supplement or replace information typically provided by throttle angle sensor 112. Vaporized or aerosolized fuel is provided to 102 via intake port or manifold 150.

The target temperature of the capillary flow passage is determined through the use of a control algorithm designed to achieve an appropriate target setpoint. The target setpoint is the ratio of the hot resistance of the capillary flow passage to the cold (unheated) resistance of the capillary flow passage (R/Ro). The ratio R/Ro, in turn, corresponds to a desired bulk capillary flow passage temperature.

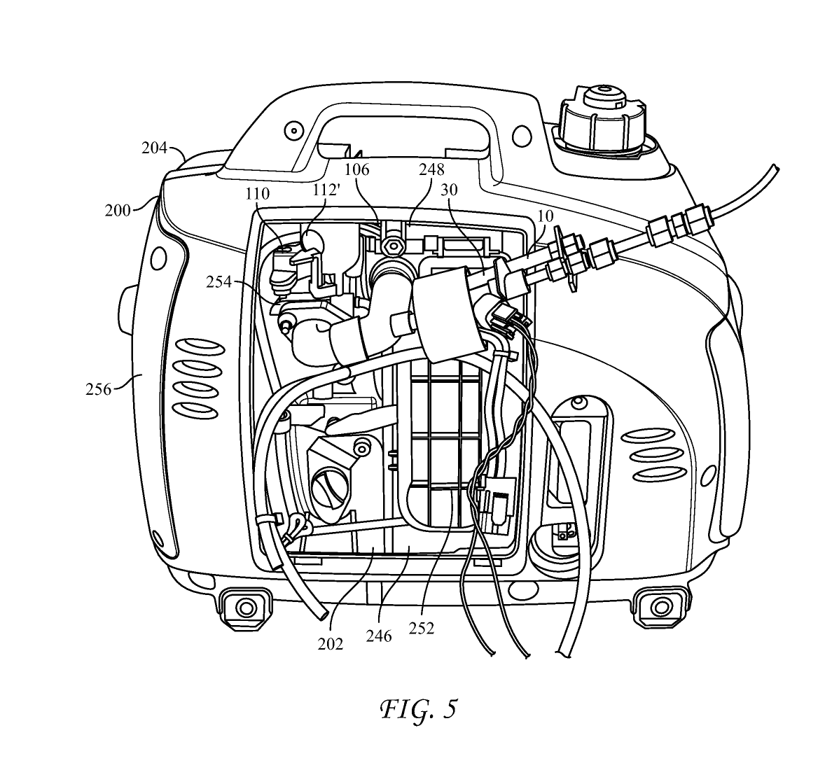

Referring now to FIG. 5, provided is a portable engine or engine-generator combination 200 having multi-fuel capability. Referring also to FIGS. 1 and 2, the portable engine-generator combination 200 includes a spark ignited internal combustion engine 202 for powering an electrical generator 252, the spark ignited internal combustion engine 202 having an air inlet 254 and an exhaust 256. Also provided is a fuel injector 10 which includes a fuel injector body 12 having a first end 14, a second end 16 and an outer surface 20. The fuel injector 10 also includes a valve assembly 20 positioned within the fuel injector body 12 and adjacent the first end 14 and a solenoid 22 for actuating the valve assembly 20, the solenoid 22 positioned within the fuel injector body 12 between the first end 14 and the second end 16.

As described hereinabove, at least one capillary flow passage 30 is positioned along the outer surface 18 of the fuel injector body 12, the at least one capillary flow passage having an inlet end 32 and an outlet end 34. A heat source 36 is arranged along the at least one capillary flow passage 30. Referring also to FIG. 4, a throttle body 106 is positioned adjacent the air inlet 254 of the spark ignited internal combustion engine 202, the throttle body 106 having a throttle 108. As shown in FIGS. 3 and 5, the throttle body 106 is structured and arranged to receive the fuel injector 10 upstream of the throttle 108. As those skilled in the art will plainly recognize, fuel injector 10 may also be located downstream of the throttle 108.

Referring again to FIG. 5, a controller 204 may be programmed to control the heating of the at least one capillary flow passage 30 to a level sufficient to permit at least a portion of the fuel to transition from a liquid state to a vapor state downstream of the fuel injector, while preventing sustained phase transition from the liquid state to the vapor state within the at least one capillary flow passage 30.

In some embodiments, the portable engine or engine-generator combination 200 includes a throttle position sensor 112′ for detecting throttle position and sending a signal to the controller 204, the controller 204 programmed to adjust fueling and/or engine parameters in response thereto.

In some embodiments, the portable engine or engine-generator combination 200 also includes an intake manifold air temperature sensor 248 for detecting intake manifold air temperature and sending a signal to the controller 204, the controller 204 programmed to adjust fueling and/or engine parameters in response thereto.

In some embodiments, the portable engine or engine-generator combination 200 also includes an engine block temperature sensor 246, for detecting engine block temperature and sending a signal to the controller 204, the controller 204 programmed to adjust fueling and/or engine parameters in response thereto.

In some embodiments, the portable engine or engine-generator combination may include a knock sensor for detecting engine knock and sending a signal to the controller 204, the controller 204 programmed to adjust fueling and/or engine parameters in response thereto.

In some embodiments, the portable engine or engine-generator combination may include an ignition signal detected by the controller 204, the controller 204 programmed to adjust fueling and/or engine parameters in response thereto.

In some embodiments, the portable engine or engine-generator combination may include a mass flow sensor or manifold vacuum sensor to determine engine air flow, send a signal to the controller 204, the controller 204 programmed to adjust fueling and/or engine parameters in response thereto.

Referring to FIGS. 3 and 5, in some embodiments, the controller 204 of the portable engine or engine-generator combination is comprised of an engine controller 114, a fueling and battery management controller 132, and a fuel injector heating controller 104.

As may be appreciated, conventional spark-ignited engines, which may include by way of example and not of limitation, portable engine-generator combinations, can be converted to multi-fuel operation using the fuel injectors and fuel systems disclosed herein. Suitable portable engine-generator combinations that may be employed for such conversions include the Honda EU Series Portable Inverter Generator series, which may be obtained from a wide variety of commercial sources, supplied by American Honda Power Equipment Division of Alpharetta, Ga., USA.

The selection of an ideal spark ignited internal combustion engine for conversion to operation on aerosolized middle-distillate fuels, while minimizing the incidence of engine knock, will depend upon engine operating parameters, such as engine speed and compression ratio, as well as the maintenance of combustion and engine head temperature, which can be influenced by air/fuel ratio, ignition and valve timing, and cooling. As those skilled in the art will recognize, spark timing can also be adjusted, if necessary, to decrease the incidence of knock. In addition, the incidence of oil dilution with fuels less volatile than gasoline, such as diesel fuel or jet fuel, can be reduced by the maintaining engine temperature above a certain threshold, which can be controlled by controlling the engine cooling system. The optimal temperature range, to be warm enough to avoid oil dilution, while cool enough to avoid engine knock, both of which would be important for long-life operation, will depend upon the specifics of the selected spark-ignition engine. The aforementioned Honda systems have been found to achieve these requirements. For the systems tested, oil temperatures in the range of 70° C. to 90° C. have been found to be optimal for both criteria.

Referring to FIGS. 1-5, disclosed herein is a kit of parts for converting a gasoline-powered engine 102 or portable engine-generator combination 200 to enable multi-fuel capability, including middle-distillate fuels not typically compatible with spark ignition engines. The kit of parts includes a fuel injector 10, which includes a fuel injector body 12 having a first end 14, a second end 16 and an outer surface 18. The fuel injector body 12 further includes a valve assembly 20 positioned within the fuel injector body 12 and adjacent the first end 14, and a solenoid 22 for actuating the valve assembly 20, the solenoid 22 positioned within the fuel injector body 12 between the first end 14 and the second end 16. The fuel injector 10 includes at least one capillary flow passage 30 positioned along the outer surface 18 of the fuel injector body 12, the at least one capillary flow passage 30 having an inlet end 32 and an outlet end 34. A heat source 36 may be arranged along the at least one capillary flow passage 30 for heating the fuel as it passes through the capillary flow passage 30.

A throttle body 106 having a throttle 108 may also be included in the kit of parts disclosed herein. In some embodiments, the throttle body 106 may be structured and arranged to receive the fuel injector 30 upstream of the throttle 108. In some embodiments, the throttle body 106 may be structured and arranged to receive the fuel injector 30 downstream of the throttle 108.

In some embodiments, the kit of parts may also include a controller 204 programmed to control the heating of the at least one capillary flow passage 30 to a level sufficient to permit at least a portion of the fuel to transition from a liquid state to a vapor state downstream of the fuel injector 10, while preventing sustained phase transition from the liquid state to the vapor state within the at least one capillary flow passage.

In some embodiments, the kit of parts may include a throttle position sensor 112′ for detecting throttle position and sending a signal to an engine controller 204, the engine controller 204 programmed to adjust fueling and/or engine parameters in response thereto. In some embodiments, the kit of parts of claim 32, further comprising an intake manifold air temperature sensor for detecting intake manifold air temperature and sending a signal to the controller, the controller programmed to adjust fueling and/or engine parameters in response thereto.

In some embodiments, the kit of parts may include an engine block temperature sensor 146, for detecting engine block temperature and sending a signal to the controller 204, the controller 204 programmed to adjust fueling and/or engine parameters in response thereto.

In some embodiments, the controller 204 further comprises an engine controller 114, a fueling and battery management controller 132, and a fuel injector heating controller 104.

Also provided herein is a process for converting a gasoline-powered engine or portable generator to enable multi-fuel capability, including middle-distillate fuels not typically compatible with spark ignition engines. The process includes the steps of providing a gasoline-powered portable generator, the generator comprising a spark ignited internal combustion engine, and an electrical generator, the spark ignited internal combustion engine having an air inlet; providing a throttle body for installation adjacent the air inlet of the spark ignited internal combustion engine, the throttle body having a throttle and structured and arranged to receive a fuel injector; providing a fuel injector for installing within the throttle body, the fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; and providing a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

In some embodiments, the process includes the step of providing a throttle position sensor for detecting throttle position and sending a signal to the controller, the controller programmed to adjust fueling and/or engine parameters in response thereto.

In some embodiments, the process includes the step of providing an intake manifold air temperature sensor for detecting intake manifold air temperature and sending a signal to the controller, the controller programmed to adjust fueling and/or engine parameters in response thereto.

In some embodiments, the process includes the step of providing an engine block temperature sensor, for detecting engine block temperature and sending a signal to the controller, the controller programmed to adjust fueling and/or engine parameters in response thereto.

In some embodiments, the controller further comprises an engine controller, a fueling and battery management controller, and a fuel injector heating controller.

Also provided herein is a method of operating a spark-ignited engine on middle-distillate fuel. The method includes supplying a middle-distillate fuel, in liquid form, to at least one capillary flow passage of a fuel injector; heating the middle-distillate fuel within the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage; and delivering a vaporized or aerosolized fuel mixture to a combustion chamber of the spark-ignited engine.

In some embodiments, aerosolization of the middle-distillate fuel is achieved while minimizing electrical heating requirements.

In some embodiments, heating the middle-distillate fuel vaporizes the lighter fractions of the middle-distillate fuel downstream of the fuel injector and atomizes the heavier fractions of the middle-distillate fuel to form an aerosolized fuel mixture.

In some embodiments, the aerosolized fuel mixture has a particle size distribution, a fraction of which is 25 μm or less prior to combustion.

In some embodiments, the method includes the step of passing the heated fuel through an orifice plate to enhance aerosolization.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and define a term in a manner or are otherwise inconsistent with either the non-incorporated portion of the present disclosure or with any of the other incorporated references, the non-incorporated portion of the present disclosure shall control, and the term or incorporated disclosure therein shall only control with respect to the reference in which the term is defined and/or the incorporated disclosure was originally present.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

Illustrative, non-exclusive examples of systems and methods according to the present disclosure have been presented. It is within the scope of the present disclosure that an individual step of a method recited herein, including in the following enumerated paragraphs, may additionally or alternatively be referred to as a “step for” performing the recited action.

### INDUSTRIAL APPLICABILITY

The systems and methods disclosed herein are applicable to the automotive, small engine, portable generator industries and to the military.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A fuel injector for delivering vaporized or aerosolized fuel mixtures to a spark ignited internal combustion engine, comprising:
(a) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end;
(b) at least one capillary flow passage positioned along the outer surface of the fuel injector body, the at least one capillary flow passage having an inlet end and an outlet end; and
(c) a heat source arranged along the at least one capillary flow passage, the heat source operable to heat the fuel within the at least one capillary flow passage to a level sufficient to permit at least a portion of the fuel to transition from a liquid state to a vapor state downstream of the fuel injector;
wherein the valve assembly comprises a valve and a valve seat, the outlet end of the at least one capillary flow passage positioned adjacent to and upstream of the valve seat to minimize heat transfer from the heated fuel to the fuel injector.

2. The fuel injector of claim 1, wherein the valve assembly and the solenoid cooperate to form an armature valve assembly, the armature valve assembly slidably resident within the fuel injector body, the armature valve assembly driven axially by the solenoid.

3. The fuel injector of claim 2, wherein the valve comprises a ball valve.

4. The fuel injector of claim 2, wherein the valve comprises a pintle valve.

5. The fuel injector of claim 1, wherein the at least one capillary flow passage is formed within a tube.

6. The fuel injector of claim 5, wherein the tube is formed from stainless steel, nickel-chromium alloy, or other resistive materials.

7. The fuel injector of claim 6, wherein the at least one capillary flow passage comprises a plurality of capillary flow passages.

8. The fuel injector of claim 7, wherein the plurality of capillary flow passages form a bundle, the bundle helically wound about the outer surface of the fuel injector body.

9. The fuel injector of claim 8, wherein the bundle is enclosed within an insulating cover.

10. The fuel injector of claim 1, further comprising an orifice plate, the orifice plate positioned at the first end of the fuel injector body and downstream of the valve assembly.

11. A fuel system having multi-fuel capability for delivering vaporized or aerosolized fuel mixtures to a spark ignited internal combustion engine, the fuel system comprising:
(a) at least one fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; and
(b) a controller programmed to control the heating of the at least one capillary flow passage to a level sufficient to permit at least a portion of the fuel to transition from a liquid state to a vapor state downstream of the at least one fuel injector, while preventing sustained phase transition from the liquid state to the vapor state within the at least one capillary flow passage.

12. The fuel system of claim 11, further comprising a throttle body having a throttle, the throttle body structured and arranged to receive the at least one fuel injector, so as to enable the fuel to transition from the liquid state to the vapor state downstream of the at least one fuel injector into a region of reduced pressure.

13. The fuel system of claim 12, wherein the valve assembly comprises a valve and a valve seat, the outlet end of the at least one capillary flow passage positioned adjacent to and upstream of the valve seat to minimize heat transfer from the heated fuel to the at least one fuel injector.

14. The fuel system of claim 13, wherein the valve assembly and the solenoid cooperate to form an armature valve assembly, the armature valve assembly slidably resident within the fuel injector body, the armature valve assembly driven axially by the solenoid.

15. The fuel system of claim 14, wherein the valve comprises a ball valve or a pintle valve.

16. The fuel system of claim 11, wherein the at least one capillary flow passage is formed within a tube.

17. The fuel system of claim 16, wherein the at least one capillary flow passage comprises a plurality of capillary flow passages.

18. The fuel system of claim 17, wherein the plurality of capillary flow passages form a bundle, the bundle helically wound about the outer surface of the fuel injector body.

19. The fuel system of claim 18, wherein the bundle is enclosed within an insulating cover.

20. The fuel system of claim 11, further comprising an orifice plate, the orifice positioned at the first end of the fuel injector body and downstream of the valve assembly.

21. The fuel system of claim 11, wherein the prevention of sustained phase transition from the liquid state to the vapor state within the at least one capillary flow passage inhibits the formation of carbonaceous deposits on heated surfaces that come in contact with fuel.

22. A portable engine or engine-generator combination having multi-fuel capability, comprising:
(a) a spark ignited internal combustion engine for powering an electrical generator, the spark ignited internal combustion engine having an air inlet and an exhaust;
(b) a fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage;
(c) a throttle body positioned adjacent the air inlet of the spark ignited internal combustion engine, the throttle body having a throttle, the throttle body structured and arranged to receive the fuel injector; and
(d) a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

23. The portable engine or engine-generator combination of claim 22, further comprising a throttle position sensor for detecting throttle position and sending a signal to the controller, the controller programmed to adjust fueling and/or engine parameters in response thereto.

24. The portable engine or engine-generator combination of claim 23, further comprising an intake manifold air temperature sensor for detecting intake manifold air temperature and sending a signal to the controller, the controller programmed to adjust fueling and/or engine parameters in response thereto.

25. The portable engine or engine-generator combination of claim 23, further comprising an engine block temperature sensor, for detecting engine block temperature and sending a signal to the controller, the controller programmed to adjust fueling and/or engine parameters in response thereto.

26. The portable engine or engine-generator combination of claim 22, wherein the controller further comprises an engine controller, a fueling and battery management controller, and a fuel injector heating controller.

27. The portable engine or engine-generator combination of claim 22, wherein the valve assembly comprises a valve and a valve seat, the outlet end of the at least one capillary flow passage positioned proximate to and upstream of the valve seat.

28. The portable engine or engine-generator combination of claim 27, wherein the valve comprises a ball valve or a pintle valve.

29. The portable engine or engine-generator combination of claim 28, wherein the at least one capillary flow passage is formed within a tube.

30. The portable engine or engine-generator combination of claim 29, wherein the at least one capillary flow passage comprises a plurality of capillary flow passages.

31. The portable engine or engine-generator combination of claim 30, wherein the plurality of capillary flow passages form a bundle, the bundle helically wound about the outer surface of the fuel injector body.

32. The portable engine or engine-generator combination of claim 22, wherein the prevention of sustained phase transition from the liquid state to the vapor state within the at least one capillary flow passage inhibits the formation of carbonaceous deposits on heated surfaces that come in contact with fuel.

33. The portable engine or engine-generator combination of claim 22, further comprising a knock sensor for detecting engine knock and sending a signal to the controller, the controller programmed to adjust fueling and/or engine parameters in response thereto.

34. The portable engine or engine-generator combination of claim 22, further comprising an ignition signal detected by the controller, the controller programmed to adjust fueling and/or engine parameters in response thereto.

35. A kit of parts for converting a gasoline-powered engine or portable engine-generator combination to enable multi-fuel capability, comprising:
(a) a fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage;
(b) a throttle body having a throttle, the throttle body structured and arranged to receive the fuel injector, and
(c) a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

36. The kit of parts of claim 35, further comprising a throttle position sensor for detecting throttle position and sending a signal to the controller, the controller programmed to adjust fueling and/or engine parameters in response thereto.

37. The kit of parts of claim 36, further comprising an intake manifold air temperature sensor for detecting intake manifold air temperature and sending a signal to the controller, the controller programmed to adjust fueling and/or engine parameters in response thereto.

38. The kit of parts of claim 37, further comprising an engine block temperature sensor, for detecting engine block temperature and sending a signal to the controller, the controller programmed to adjust fueling and/or engine parameters in response thereto.

39. The kit of parts of claim 35, wherein the controller further comprises an engine controller, a fueling and battery management controller, and a fuel injector heating controller.

40. The kit of parts of claim 35, wherein the valve assembly comprises a valve and a valve seat, the outlet end of the at least one capillary flow passage positioned proximate to and upstream of the valve seat to minimize heat transfer from the heated fuel to the fuel injector.

41. The kit of parts of claim 40, wherein the valve comprises a ball valve or a pintle valve.

42. The kit of parts of claim 41, wherein the at least one capillary flow passage is formed within a tube.

43. The kit of parts of claim 42, wherein the at least one capillary flow passage comprises a plurality of capillary flow passages.

44. The kit of parts of claim 43, wherein the plurality of capillary flow passages form a bundle, the bundle helically wound about the outer surface of the fuel injector body.

45. The kit of parts of claim 35, wherein the prevention of sustained phase transition from the liquid state to the vapor state within the at least one capillary flow passage inhibits the formation of carbonaceous deposits on heated surfaces that come in contact with fuel.

46. A process for converting a gasoline-powered engine or portable generator to enable multi-fuel capability, comprising:
providing a gasoline-powered portable generator, the generator comprising a spark ignited internal combustion engine, and an electrical generator, the spark ignited internal combustion engine having an air inlet;
providing a throttle body for installation adjacent the air inlet of the a spark ignited internal combustion engine, the throttle body having a throttle and structured and arranged to receive a fuel injector;
providing a fuel injector for installing within the throttle body, the fuel injector comprising (i) a fuel injector body having a first end, a second end and an outer surface, the fuel injector body comprising a valve assembly positioned within the fuel injector body and adjacent the first end, and a solenoid for actuating the valve assembly, the solenoid positioned within the fuel injector body between the first end and the second end; (ii) at least one capillary flow passage positioned along the outer surface of the fuel injector body, the at least one capillary flow passage having an inlet end and an outlet end; and (iii) a heat source arranged along the at least one capillary flow passage; and
providing a controller programmed to control the heating of the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage.

47. The process of claim 46, further comprising the step of providing a throttle position sensor for detecting throttle position and sending a signal to the controller, the controller programmed to adjust fueling and/or engine parameters in response thereto.

48. The process of claim 47, further comprising the step of providing an intake manifold air temperature sensor for detecting intake manifold air temperature and sending a signal to the controller, the controller programmed to adjust fueling and/or engine parameters in response thereto.

49. The process of claim 47, further comprising the step of providing an engine block temperature sensor, for detecting engine block temperature and sending a signal to the controller, the controller programmed to adjust fueling and/or engine parameters in response thereto.

50. The process of claim 46, wherein the controller further comprises an engine controller, a fueling and battery management controller, and a fuel injector heating controller.

51. The process of claim 46, wherein the valve assembly comprises a valve and a valve seat, the outlet end of the at least one capillary flow passage positioned proximate to and upstream of the valve seat.

52. The process of claim 51, wherein the valve comprises a ball valve or a pintle valve.

53. The process of claim 52, wherein the at least one capillary flow passage is formed within a tube.

54. The process of claim 53, wherein the at least one capillary flow passage comprises a plurality of capillary flow passages.

55. The process of claim 54, wherein the plurality of capillary flow passages form a bundle, the bundle helically wound about the outer surface of the fuel injector body.

56. The process of claim 46, wherein the prevention of sustained phase transition from the liquid state to the vapor state within the at least one capillary flow passage inhibits the formation of carbonaceous deposits on heated surfaces that come in contact with fuel.

57. A method of operating a spark-ignited engine on vaporized or aerosolized middle-distillate fuel comprising:
(a) supplying a middle-distillate fuel, in liquid form, to at least one capillary flow passage of a fuel injector;
(b) heating the middle-distillate fuel within the at least one capillary flow passage to a level sufficient to permit at least a portion of the fuel to transition from a liquid state to a vapor state downstream of the fuel injector, while preventing sustained phase transition from the liquid state to the vapor state within the at least one capillary flow passage; and
(c) delivering a vaporized or aerosolized fuel mixture to a combustion chamber of the spark-ignited engine.

58. The method of claim 57, wherein aerosolization of the middle-distillate fuel is achieved while minimizing electrical heating requirements.

59. The method of claim 58, wherein heating the middle-distillate fuel vaporizes the lighter fractions of the middle-distillate fuel downstream of the fuel injector and atomizes the heavier fractions of the middle-distillate fuel to form an aerosolized fuel mixture.

60. The method of claim 59, wherein the aerosolized fuel mixture has a particle size distribution, a fraction of which is 25 μm or less prior to combustion.

61. The method of claim 60, further comprising the step of passing the heated fuel through an orifice plate to enhance aerosolization.

62. The method of claim 57, wherein the prevention of sustained phase transition from the liquid state to the vapor state within the at least one capillary flow passage inhibits the formation of carbonaceous deposits on heated surfaces that come in contact with fuel.

63. A method of vaporizing or aerosolizing a full-boiling range fuel, comprising the steps of:
supplying a full-boiling range fuel, in liquid form, to at least one heated flow passage;
heating the full-boiling range fuel within the at least one heated flow passage to a level sufficient to permit a portion of the full-boiling range fuel to transition from a liquid state to a vapor state downstream of the at least one heated flow passage,
subjecting the remaining liquid portion of the full-boiling range fuel downstream of the at least one heated flow passage fuel to partial flash vaporization to fully vaporize or aerosolize the full-boiling range fuel.

64. The method of claim 63, wherein the at least one heated flow passage comprises at least one capillary flow passage.
